(19) United States
(12) Patent Application Publication
(10) Pub. No.: US 2003/0097363 A1
(43) Pub. Date: May 22, 2003

(54) Method and computer system for storage of data structure business rules using UML class diagrams

(76) Inventor: Paul R. Dorsey, Colonia, NJ (US)

Correspondence Address: MANDEL & PESLAK, LLC, Suite 5, 80 Scenic Drive, Freehold, NJ, 07728, US

(21) Appl. No.: 09/906,163

(22) Filed: Jul. 16, 2001

Related U.S. Application Data
(60) Provisional application No. 60/218,762, filed on Jul. 17, 2000.

(51) Int. Cl. G06F 7/00

(52) U.S. Cl. 707/100

(57) ABSTRACT

The present invention relates to a method and computer system to support the storage and display of business rules, specifically data structure business rules, implemented as data in a database. Because the rules are stored as data, it is easier for a user to enter new rules or modify existing rules in a database than in traditional database systems where the rules are implemented as data structures and procedural code.

The present application claims priority from a provisional application entitled “Method and Computer System for Storage and Enforcement of Business Rules,” Serial No. 60/218,762, filed on Jul. 17, 2000 and now pending.

### FIELD OF THE INVENTION

The present invention relates to a method and computer system to support the storage and display of data structure business rules implemented in a database.

### BACKGROUND OF THE INVENTION

There is a need for users to define and code their own business rules. Today's programming languages and rule-based systems are complex, and are mastered only by programmers, and not by end users. Users today are unable to write programs in a third generation language in order to manipulate data. Providing an environment or system in which users can specify their own business rules in an easily understandable format greatly increases the control that users have over their systems, and allows them to maintain their own business rules. The current existing alternatives for incorporating business rules into information systems, namely code or program generators, are inadequate because they do not store the business rules in a database (repository), but instead in a third generation or procedural language.

Those of ordinary skill in the art recognize that a business rule is the combination of validation edits, logon verifications, database lookups, policies, and algorithmic transformations that constitute an enterprise's way of doing business. The term “business logic” is also used interchangeably with “business rules.” There are several ways to represent and implement business rules, including program logic, entity-relationship diagrams (ERDs), and rule grammars, each of which has its advantages and disadvantages. Program logic (code) can represent any business rule, but it is difficult to write good, reusable code that is easy to modify and maintain. Code is also difficult for users to understand.

Entity-relationship diagrams (ERDs) capture some rules very efficiently, but cannot store many types of structural business rules, such as inheritance. Business rule grammars can be used to design and support business rules, but they are unworkable for large systems.

In response to the deficiencies in the current state of the art, the present invention provides novel methods and computer systems to support the entry and storage of business rules in a more user-friendly, efficient and effective manner as data in the computer system. This approach avoids the shortcomings and drawbacks of prior methodologies.

### SUMMARY OF THE INVENTION

The present invention allows users to identify, describe and store their rules, including data structure business rules, in a database, or other rule repository, thus minimizing the need for traditional code. The rule identification, description, and storage are accomplished by a system that can support any requirements using completely abstract data structures for common core objects. In other words, according to the present invention, the rule repository includes not only the rules themselves, but also the structure of the rules. Typically, databases capture only information as data, while program code captures the business rules. Storing business rules as data rather than code means that it is then maintainable by people who actually use the rules rather than programmers. Thus, the actual user can maintain his or her own business rules without the necessity of seeking assistance from the computer programmer.

Business rules may be divided into two categories:

1. Structural business rules: Rules indicating the types of information to be stored and how those information elements interrelate are structural. A structural rule is one that is defined by the data structure independent of the process. This category of rules are largely state and time independent. These rules may include everything from “Vice Presidents report to President” to “Employees work in Departments.” All information traditionally stored in a relational ERD is structural. An ERD diagrammatically shows the information groupings in the database (entities), the individual information elements (attributes) and, to a limited extent, how the information elements are related (relationships). This is a very limited “grammar” for business rules, but clearly is a type of business rule repository.

2. Process business rules: This category of rules relates to workflow and state dependent rules. Rules pertaining to the way documents are processed in an organization, such as the approval process for a large purchase order, are procedural in nature.

The present invention is directed to the storage and implementation of structural business rules. The present invention is not directed to process-related business rules.

The present invention, in a further aspect, allows users to define their business rules using a Unified Modeling Language (UML) repository, which is consistent with relational or object-relational principles. Some structural rules are not easy to represent in an ERD. For this reason, the Unified Modeling Language was selected as the communication vehicle best suited to the invention and its associated method. Because of its status as an emerging standard, its extensibility, and its ability to store more complex rules than ERDs, UML class diagrams are better able to represent core structural information. Anything that can be represented in an ERD can be represented in UML with the additional advantage of reflecting inheritance relationships in UML that are not possible to represent in ERDs. Even simple rules involving the relationship between two database attributes such as the standard constraint that a starting date must precede an ending date usually cannot be represented in an ERD. Additional structural rules that cannot be represented in UML will be handled using PL/SQL-based class triggers or extensions to UML syntax. As is known by those of ordinary skill in the art, PL/SQL is the language used to communicate with Oracle® databases.

The present invention further contributes to the construction of systems that make code maintenance easier for programmers. For example, using the method and computer system for storage of business rules described here, by changing and regenerating a few lines of code it is possible to make system modifications without rewriting hundreds of lines of procedural code. Because of the flexible nature of the underlying structures, the ongoing maintenance costs of the system will be greatly reduced. Since all of the business rules are stored in a repository, new business rules can be easily accommodated without changing the underlying data structures or requiring any of the current applications to be modified.

This invention also provides a generic database structure that allows users to define and store complex objects. By writing the applications using these generic data structures as much as possible, it is possible to add attributes, change the validation rules for attributes, or change the cardinalities associated with objects, without requiring changes to the underlying structures or the existing applications.

In yet another aspect, the present invention provides a method and system to allow a user to display or print the stored business rules.

Finally, the most valuable aspect of the present method and computer system for storage of business rules is that the invention models both the data and the data structure, making it possible for a wide variety of functions, companies, and industries (such as, e.g., a retailer or tax organization) to utilize and implement the same system.

### BRIEF DESCRIPTION OF THE DRAWINGS

For a more complete understanding of the invention, the following Detailed Description should be read in conjunction with the accompanying Drawings, wherein:

FIG. 1A is a schematic representation (logical, entity-relationship diagram) of a simple Transaction and Transaction Detail example;

FIGS. 1B-1C show the entities represented in FIG. 1-A in table format and list the attributes associated with each entity as well as the properties for each attribute;

FIGS. 1D-1E list sample data for the various Entities shown in FIGS. 1B-1C;

FIG. 2 is an overview of an embodiment of the present invention;

FIG. 3 is the logical, entity-relationship diagram (a schematic diagram) of the relational database design (the data model) used in the construction of an illustrative embodiment of the overall application of the present invention;

FIGS. 4-A to 4-F show the Entities represented in FIG. 3 in table format and list the attributes associated with each entity as well as the relevant properties for each attribute;

FIGS. 5-A to 5-F provide sample data for the entities and tables shown in FIGS. 4A-4F.

FIG. 6 is the example UML diagram representing the data contained in FIGS. 5A-5F.

### DETAILED DESCRIPTION OF THE INVENTION

The present invention will now be described with reference to a particular embodiment of the present invention, i.e., one type of graphical data modeling of entity-relationship diagrams (ERDs). Entity-Relationship Diagrams are well-known to those of ordinary skill in the art and have a specific meaning to database designers and developers. ERDs consist of two major parts, i.e., entities, and relationships.

FIG. 1A is an example of a simplistic Entity-Relationship Diagram.

An entity is something of interest in the system being designed. The rectangular box represents an entity, and the first line of text in the box is the name of the entity. The second line of text in the box, with a pound sign (“#”), is the primary key (PK). The primary key is the unique identifier of data in the table. In the case of the ERD shown in FIG. 1A the name of the entity is “Transaction,” and “Transaction_CD” is the primary key. The text in the following lines represent attributes. As shown in Table I, there are two types of attributes, namely “not null” attributes (i.e., mandatory attributes) where users must enter information, (indicated with an asterisk (“*”)); and nullable attributes (i.e., optional attributes) which may or may not have information entered (indicated with the letter “o”). For example, in the Transaction entity, the attribute “Name_TX” is mandatory, whereas the attribute “Descr_TX” is optional.

TABLE I

| Symbol | Meaning |
|---|---|
| # | Primary Key |
| * | Not Null Field (i.e., mandatory) |
| o | Nullable Field (i.e., optional) |

Relationships are represented in the Figures by lines between entities. There are a few types of relationships. The line made up of a dotted and solid line ending in a three-pronged form in the example in FIG. 1A represents a one-to-many relationship. In a one-to-many relationship, the primary key of Transaction (i.e., Transaction_CD) becomes the foreign key of the many, Transaction_Dtl. The name of the foreign key is denoted by the name in the table with an “FK” suffix added, i.e., Transaction_CD_FK. In this example, it is interpreted as Transactions have one or more Transaction details associated with them. The Transaction has Transaction Details associated with it; and Transaction Details are for a specific Transaction.

Each entity can be supported by a table in the database. The tables corresponding to the Transaction entity and Transaction_Dtl entity are the Transaction table in FIG. 1B and Transaction_Dtl table in FIG. 1C. (FIG. 1C is a physical schematic representation of the Entity entitled Transaction_Dtl, the various information fields thereof, the type of information contained therein, and the relationships contained therein.) The first field in the table is the attribute name. The second field is the sequence number for the attribute. The third field is a Boolean value indicating whether or not the attribute is optional. The fourth field is the physical format of the attribute; the fifth field is the length of the attribute; and the sixth field is the number of decimal places.

Some sample data for Transaction and for Transaction_Detail are shown in FIGS. 1D and 1E. The column headings in FIGS. 1D and 1E correspond to the attributes in the Entity-Relationship Diagrams. In the Transaction table, there are two types of transactions; their names are “buy product transaction,” and “sell product transaction.” The Transaction_Detail table consists of three details. The first transaction detail is that a product was bought on Nov. 1, 1999; the second transaction detail is that a product was bought on Nov. 5, 1999; and the third transaction detail is that a product was sold on Nov. 1, 1999.

The presently preferred embodiment of the present invention is as implemented into a computer systems described here, with reference to FIGS. 2 through 4. FIG. 2 is an overview of an embodiment of the present invention. In general, the system of the present invention (hereinafter “the System”) may be realized in a variety of ways depending upon the enabling technology available at the time of realization, and particular application requirements. In the illustrative embodiment, the System is realized as a decentralized network of computers, but as is obvious to those of ordinary skill in the art, it could also be implemented in a centralized computing environment.

As shown in FIG. 2, a computer system (100) includes a rule engine (102), which enforces the business rules stored in the data model business rules (BR) repository (104). The application of the rule engine (102) using the data model BR repository (104) along with a user's input (106) produces a database (108).

FIG. 3 is a logical, entity-relationship diagram (a schematic diagram) of the relational database design used in the construction of an illustrative embodiment of the overall application of the present invention. FIG. 3 shows the entities, their attributes and the relationships between the entities, and the important characteristics and advantages of the design.

A UML rule allows a user to specify groups of business rules stored within a collection of many UML repositories, in the entity UML Rule (UML_Rule). Each row represents a different UML class model. The significance of this design is that it enables multiple clients to store their information in the same database, where each client has its own UML rule. The user can also define the type of UML rule.

UML rule class represents an object class in a UML diagram, in the entity UML Rule Class (UML_Rule_Class). The user specifies which UML rule is associated with each UML class in UML rule Class, and is represented in the entity UML Rule Class (UML_Rule_Class). The significance of this entity is that it allows different rules to be associated with different classes.

UML attribute class represents an attribute that is associated with a class in a rule set, and is specified in the entity UML Attribute Class (UML_Attrib_Class). The user defines a UML attribute class, which represents the association of an attribute with a class in a particular rule.

UML association represents the relationship connecting one or more classes with each other or one or more associations with each other, and is specified in the entity UML_Association (UML_Assoc). Every instance of a relationship belongs to a rule. For associations, the line may have a verb associated with it. For generalizations, the line may have a name associated with it. Valid types of associations are Associations, Aggregation, Composition and Generalization.

UML association detail represents the elements (classes and associations) with a particular association. Each association has one head end and one tail end. A generalization may have multiple tails.

UML keyword represents a stereotype, constraint, or assigned keyword (with or without a specified value) associated with attributes, classes or associations.

### Specification of the Information Structures Comprising The Relational Database of the Present Invention

FIGS. 4-A to 4-F show details of the various Entities, their respective attributes, the type of information contained therein, and the relationships contained therein. More specifically,

FIG. 4-A is a representation of the Entity entitled UML_Assoc, the various information fields thereof, the type of information contained therein, and the relationships contained therein;

FIG. 4-B is a representation of the Entity entitled UML_Assoc_Dtl, the various information fields thereof, the type of information contained therein, and the relationships contained therein;

FIG. 4-C is a representation of the Entity entitled UML_Atrib_Class, the various information fields thereof, the type of information contained therein, and the relationships contained therein;

FIG. 4-D is a representation of the Entity entitled UML_Rule_Class, the various information fields thereof, the type of information contained therein, and the relationships contained therein;

FIG. 4-E is a representation of the Entity entitled UML_Key_Word, the various information fields thereof, the type of information contained therein, and the relationships contained therein;

FIG. 4-F is a representation of the Entity entitled UML_Rule, the various information fields thereof, the type of information contained therein, and the relationships contained therein; and

With reference to FIG. 4A (UML_ASSOC), the user identifies which rule is associated, by specifying the following attributes in a database table. First, each UML Association needs to have a unique identifier. This is done by specifying Assoc_ID as the primary key. The user then specifies the rule, by using Rule_ID as a foreign key from UML_Rule, resulting in Rule_ID_FK. Foreign Key (FK) relationships are not explicitly shown in the generated ERD diagrams so RULE_ID_FK will not be listed in the UML_ASSOC attribute but is represented there by the one-to-many relationship line drawn between UML_RULE and UML_ASSOC in FIG. 3. The user has the option of specifying a description for the association in the attribute Descr_TX. The user then has the option of specifying the verb, in the attribute Verb_TX. Finally, the user can enter the type of association, in the attribute Z_Assoc_CD. A valid type of association, for example, could be aggregation, composition or generalization.

With reference to FIG. 4B (UML_ASSOC_DTL), the user then defines the associations by specifying the following attributes in a database table, UML_Assoc_Dtl. First, each rule association needs to have a unique identifier. This is done by specifying the attribute Assoc_Dtl_ID to be the primary key. The user identifies the parent association, if one exists, which can also be referred to as the superordinate association. The user can then specify the cardinality of the association, in the attribute Card_TX. The user can then specify the role, in Role_TX. Role refers to the role that the class plays in that relationship. Finally, the user can specify the type of association, in the attribute Z_Assoc_Dtl_CD.

With reference to FIG. 4C (UML_ATTRIB_CLASS), the user identifies a UML attribute by specifying the following attributes in a database table. First, each attribute needs to have a unique identifier. This is done by specifying Attrib_ID as the primary key. The user then must specify a code, in the attribute Attrib_CD. The user then has the option of specifying a name for the UML attribute, in the attribute Name_TX. Next, the user can specify a description for the UML attribute in the attribute Descr_TX using CLASS_ID.

With reference to 4D (UML_RULE_CLASS), the user identifies the classes by specifying the following attributes in a database table. Each class must be associated with a rule. First, each class needs to have a unique identifier. This is done by specifying Class_ID as the primary key. The class code is specified in CLASS_CD (Employee, Person). The user then specifies the name of the class in the attribute Name_TX. The user has the option of specifying a description of the class in the attribute Descr_TX. A valid type of host table can be UML_OBJECT. Each class has a host table. When initiating an object belonging to a class, the HOST_TABLE attribute indicates where to store objects of that class. The user can specify which rule is associated with which class by using Rule_ID as a foreign key from UML_Rule, resulting in Rule_ID.

With reference to FIG. 4E, the user then defines the keywords by specifying the following attributes in a database table, UML_Key_Word. First, each keyword needs to have a unique identifier. This is done by specifying the attribute Key_Word_ID to be the primary key. The user then specifies the association of interest, by using Assoc_ID as a foreign key from UML_Assoc, resulting in Assoc_ID. The user then specifies the relevant class attribute, by using Attrib_ID as a foreign key from UML_Attrib_Class, resulting in Attrib_ID_FK. Next, the user specifies which rule is relevant, by using CLASS_ID from UML_RULE_CLASS, resulting in CLASS_ID_FK. The user has the option to specify a description, in Descr_TX. Finally, the user can specify the type of keyword, in Z_Key_Word_CD.

With reference to FIG. 4F (UML_RULE) the user defines the rule by specifying the following attributes in a database table. First, each rule needs to have a unique identifier. This is done by specifying Rule_ID as the primary key. The system automatically generates the value for this field, and does so for all primary keys throughout in all of the system. Second, the user has the option of specifying the name of the rule in the attribute Name_TX. The user also has the option of specifying a description of the rule in Descr_TX. Finally, the user has the option of specifying the type of rule in Z_Rule_CD. A valid type of UML rule, for example, could be “Development” or “Production.”

The significance of these six entities is that they are sufficient to capture and represent any data structure business rules, as well as other types of business rules, at a high level of abstraction, allowing for system flexibility and increased efficiency in system design, development, and implementation.

The repository, as specified in FIGS. 4A-4H, can store a UML class model. The user then enters his or her own data in the above repository by using the following procedures.

To enter, insert or create a new object in the database, the user (or user application) runs the following create_object procedure:

PROCEDURE create_object

(in_class_cd varchar2,
out_object_id OUT number,
in_base_object_table varchar2 :=null,
in_base_object_id number :=null) ;

where

in_class_cd stores the class of the new object,

out_object_id is an out parameter which returns a reference number that can be used to reference the new object that is waiting to be validated

in_base_object_table stores the class code of the generalization object, and

in_base_object_id stores the reference number of the object.

This code shown is merely an illustrated example. As would be obvious to those of ordinary skill in the art, there can be several different versions of this procedure.

After creating the objects, the user (or user application) then calls the create_assoc procedure to enter or insert or create associations among new and existing objects in the database:

PROCEDURE create_association

(in_end_object_table varchar2,
in_end_object number,
in_verb varchar2,
in_head_object_table varchar2,
in_head_object number,
out_assoc_id out number) ;

where

in_end_object_table stores the class or the table name of the end object

in_end_object stores the reference number of the end object in that class or table

in_verb stores the name of the association.

in_head_object_table stores the name of the class or the table of the head object

in_head_object stores the reference number of the object in that class or table

out_assoc_id is an out parameter that returns a number to reference the new association

If a user wants to delete an existing object from a database, the following delete_object procedure is run:

PROCEDURE delete_object
(in_table_cd varchar2,
in link id number);

where

IN_TABLE_CD stores the name of class or the table of the object.

IN_LINK_ID stores the reference number of the object.

If a user wants to delete an existing association from the database, the Procedure delete_association procedure is run. This procedure is an overloaded procedure. Consequently, in the first procedure, the association is directly referenced using the table name and the reference number. However, in the second procedure, associated objects and the association name are used to reference the association. This is an indirect way to point to the association.

PROCEDURE delete_assoc

(in_table_cd varchar2,
in_link_id number);

PROCEDURE delete_assoc

(in_end_object_table varchar2,
in_end_object number,
in_verb varchar2,
in_head_object_table varchar2,
in_head_object number) ;

where

IN_TABLE_CD stores the name of the table in which the association resides.

IN_LINK_ID stores the reference number of the association in that table.

IN_END_OBJECT stores the name of the class or the table name of the end object

IN_END_OBJECT stores the reference number of the end OBJECT.

IN_VERB stores the association name.

IN_HEAD_OBJECT_TABLE stores the name of the class or the table of the head object.

IN_HEAD_OBJECT_ID stores the reference number for the object.

If the user wants to set the value of an attribute in the database, he/she calls the SET_ATTRIBUTE procedure.

Finally, the UML.engine procedure is used to validate and execute the DML request list created using the procedure above. Using the Create, Update and Delete procedures, a list of requests is created called a UML script. The UML engine analyzes the script and checks to see if it is consistent with the data model in the repository. This is called the validation process. After the script is validated, the engine executes the commands in the script. After the script is successfully processed, there is a host table and a database reference number assigned for each new item in the script. These values are available until the engine starts to work on a new script.

Method of Using the Present Invention

The following example illustrates how this process and computer system can be employed in practice using sample data. Columns left blank in the appended FIGS. 5A through 5F are considered to have null values.

FIG. 5A is an example of sample data in the Entity and Table entitled UML_ASSOC. The columns in this table are attributes of the relevant associations. Descriptions of the columns are as follows:

| | |
|---|---|
| ASSOC_ID | This column contains the ID number for the |
| | association. For example, the association in line 1 |
| | has an ID #9055 |
| Z_ASSOC_CD | This column declares the type of association such |
| | as a simple association (ASSOC - line 1) |
| | or generalization (GENER - line 2) |
| VERB_TX | This column lists the names of the associations. |
| DESCR_TX | This column can be used to add any narrative |
| | description of the association, if needed. |
| CREAT_DT | This column contains the date that the association |
| | was created |
| CREAT_BY | This column indicates who created the |
| | association. |
| MOD_DT | This column indicates the date that the association |
| | was last modified. |
| MOD_BY | This column indicates who last modified the |
| | association. |
| RULE_ID | This column indicates the ID number of the |
| | rule from the UML_RULE table |
| | (See FIG. 5F) linked to the association. |
| GENER_NAME_TX | If the association is of type Generalization |
| | (as in Line 2), and there are multiple |
| | generalizations for a class, this column stores |
| | the name of the generalization. |
| | Generalization names are not normally needed. |
| VERB_NAME_TX | This is the user-friendly verb describing the |
| | association for use in applications. |

FIG. 5B is an example of sample data in the Entity and Table entitled UML_ASSOC_DTL. The columns in this table are attributes of the relevant associations.

Descriptions of the columns are as follows:

| | |
|---|---|
| ASSOC_DTL_ID | This column contains the ID number for the |
| | association detail. |
| | For example, the association in line 1 has an |
| | ID #9086. |
| Z_AS SOC_DTL_CD | This column describes the endpoints of the |
| | association lines defined in the |
| | Z_ASSOC_CD column of the |
| | UML_ASSOC table. |
| | Simple associations have one head and one |
| | end. |
| | Generalizations have one head and one or |
| | more ends. |
| ROLE_TX | Name of the association end usually referring |
| | to the role that objects of the end class play |
| | in the association. |
| CARD_TX | This column shows the cardinality of the end |
| | point of the association line. |
| | (Ex. 0...1*, 0...1, 1, etc.) |
| CREAT_DT | This column contains the date that the |
| | association detail was created |
| CREAT_BY | This column indicates who created the |
| | association detail. |
| MOD_DT | This column indicates the date that the |
| | association detail was last modified. |
| MOD_BY | This column indicates who last modified |
| | the association detail. |
| ASSOC_ID | This column lists the ID of the association |
| | with which the association detail is |
| | connected (from UML_ASSOC - FIG. 5A) |
| ASSOC_ID_END | Some associations connect to other association |
| | lines. This column identifies the endpoint of an |
| | association line that connects other |
| | associations. |
| CLASS_ID | This column defines the class to which the |
| | associated end point is attached. |

FIG. 5C is an example of sample data in the Entity and Table entitled UML_ATTRIB_CLASS. The columns in this table are attributes of the relevant associations. Descriptions of the columns are as follows:

| | |
|---|---|
| ATTRIB_ID | This column contains the ID number for the object |
| | attribute which uniquely identifies the roles in the |
| | table. For example, the attribute class in line 1 has |
| | an ID #9066. |
| ATTRIB_CD | This column lists the formal name of the attribute. |
| NAME_TX | This column contains the user-friendly name of the |
| | attribute class. |
| | (NOTE: Currently, these names may be changed by |
| | users) |
| MIN_TIMES_NR | This column indicates the number of times that the |
| | attribute can occur in the class. 0 = optional, |
| | 1 = mandatory |
| MAX_TIMES_NR | The maximum is always 1 except in the case of |
| | multi-valued attributes. |
| CREAT_DT | This column contains the date that the attribute class |
| | was created |
| CREAT_BY | This column indicates who created the attribute |
| | class. |
| CLASS_ID | This colunm contains the ID number of the class |
| | with which the attribute is associated. |
| DOMAIN_CD | This column lists the names of the domains |
| | associated with the attribute governing the |
| | allowable values for the attribute. |
| ORDER_NR | The numbers in this column indicate the order of |
| | attributes within the class. |

FIG. 5D is an example of sample data in the Entity and Table entitled

UML_RULE_CLASS;

| | |
|---|---|
| CLASS_ID | This column contains the ID number for the rule |
| | class. For example, the association in line 1 has an |
| | ID #9052. |
| CLASS_CD | This column contains the names of the rule classes |
| | (Unit, GlJe) |
| PK_TX | This column contains a comma delimited list of the |
| | primary key (PK) components. PK components can |
| | be attributes, associations or generalizations. |
| DISP_FUNCT_CD | This column lists the names of the functions |
| | used to display objects in the class. |
| CREAT_DT | This column contains the date that the rule class was |
| | created |
| CREAT_BY | This column indicates who created the rule class. |
| MOD_DT | This column indicates the date that the rule class |
| | was last modified. |
| MOD_BY | This column indicates who last modified the rule |
| | class. |
| RULE_ID | This column lists the ID # of the rule associated |
| | with the class |
| HOST_TABLE | This column indicates the name of the physical table |
| | where the data will be stored. |
| NAME_TX | This column lists the user-friendly name for the rule |
| | class. |
| SCHEMA_TX | The column indicates the DBMS schema that is used |
| | to store the generated table. |

FIG. 5E is an example of sample data in the Entity and Table entitled

UML_KEY_WORD;

| | |
|---|---|
| KEY_WORD_ID | This column contains the ID number for the |
| | primary key of the keyword. |
| Z_KEY_WORD_CD | This column lists the name of the relevant |
| | keyword. |
| VALUE_TX | This column indicates the value of the |
| | keyword. |
| | For example, a keyword may have an |
| | associated parameter value such as |
| | “physical table name” which |
| | would indicate the name of the physical |
| | table to be generated from a class, if |
| | different from the class code. |
| DESCR_TX | Description of the object that designers can |
| | use for documentation purposes. |
| CREAT_DT | This column contains the date that the |
| | keyword was created |
| CREAT_BY | This column indicates who created the |
| | keyword. |
| MOD_DT | This column indicates the date that the keyword |
| | was last modified. |
| MOD_BY | This column indicates who last modified the |
| | keyword. |
| ATRIB_ID | This column indicates the attribute to which |
| | the keyword is attached. Only one is filled |
| | in for any particular row in the table. |
| CLASS_ID | This column indicates the class to which the |
| | keyword is attached. For example 9052 is the |
| | Unit class from the UML_RULE_CLASS |
| | table. |
| ASSOC_ID | This column indicates the association to which |
| | the keyword is attached. |

FIG. 5F is an example of sample data in the Entity and Table entitled

| | |
|---|---|
| RULE_ID | This column contains the ID number for the rule. For example, the rule in line |
| | 1 has an ID #9051. |
| NAME_TX | This column lists the names of the rules. |
| ACTIV_YN | This column indicates whether or not the rule is active (Y) or inactive (N). |
| DESCR_TX | This column may contain any relevant descriptions for documentation |
| | purposes. IN this case, the column is storing the date when the rule was |
| | generated. |
| CREAT_DT | This column contains the date that the rule was created |
| CREAT_BY | This column indicates who created the rule. |
| MOD_DT | This column indicates the date that the rule was last modified. |
| MOD_BY | This column indicates who last modified the rule. |
| SCHEMA_TX | This column lists the default schema, which stores all generated tables. |
| INSTD_YN | This column indicates whether or not the rule has been physically instantiated |
| | for production use. |

FIG. 6 is the UML class diagram from which the sample data is drawn.

Those of ordinary skill in the art will recognize that the embodiments just described merely illustrate the principles of the present invention. Many modifications may be made thereto without departing from the spirit and scope of the invention as set forth in the following claims.

What is claimed is:

1. A method of defining, storing, and displaying business rules, including data structure business rules, in a secure, single user or multi-user computing environment, comprising the steps of:
a) providing a database comprising a plurality of database tables;
b) creating a plurality of Unified Modeling Language (UML) rules by specifying a name, a description, and a type of UML rule, which are then each stored in one of the plurality of database tables called UML_RULE;
c) creating a plurality of UML classes by specifying a name and a description which are then each stored in one of the plurality of database tables called UML_RULE_CLASS;
d) defining which of the plurality of UML rules are associated with which of the plurality of UML classes, by specifying a particular UML rule and a particular UML class and then storing the definition in one of the plurality of database tables called UML_RULE_DTL;
e) creating a plurality of UML attributes, by specifying a name, a code, and a description for each of the plurality of UML attributes and storing each of the UML attributes in one of the plurality of database tables called UML_ATTRIB_CLASS;
f) defining which of the plurality of UML attributes are associated with which of the plurality of UML classes in one of the plurality of UML rules, by specifying UML attributes and one of the plurality of UML rule details, the maximum and minimum number of times, whether it is required, a particular UML attribute (Attrib_ID), and a particular UML rule class (CLASS_D), stored in one of the plurality of database tables called UML_ATTRIB_CLASS;
g) defining which of the plurality of UML classes are associated with which other classes, by specifying a verb and a description in one of the plurality of database tables called UML_ASSOC;
h) defining parent/child associations by specifying a parent association, a child association, the UML class, a cardinality, and a role, in one of a plurality of database tables called UML_ASSOC_DTL;
i) specifying a keyword, by specifying a particular association, a particular UML class attribute, a particular UML rule class, and a description in a database table called UML_KEY_WORD;
j) inserting a new object into the database, using a create_object procedure.
k) running a create_association procedure to enter or insert or create associations among new and existing objects in the database;
l) running a create_attribute procedure to enter or insert or create new attributes for the objects; and
m) running a UML.engine procedure to validate and execute a DML request list.

2. A computer system for defining, storing and displaying data structure business rules comprising:
a) a data model business rules repository which stores a plurality of data structure business rules;
b) a rule engine which enforces the data structure business rules in response to a particular user input and thereby creates an output;
c) a database for storing the output from the rule engine; and
d) means for displaying the output stored in the database.
